(19) United States
(12) Patent Application Publication
(10) Pub. No.: US 2026/0147624 A1
(43) Pub. Date: May 28, 2026

(54) ORCHESTRATION AND MANAGEMENT OF HETEROGENEOUS COMPUTING RESOURCES

(71) Applicant: Hewlett Packard Enterprise Develpment LP, Spring, TX (US)

(72) Inventors: Brian David Wheeler, Cherry Hills Village, CO (US); David Rabon Estes, Westfield, IN (US)

(21) Appl. No.: 18/962,344

(22) Filed: Nov. 27, 2024

(51) Int. Cl. G06F 9/50

(52) U.S. Cl. CPC G06F 9/5027

(57) ABSTRACT

Methods and systems for managing heterogeneous cloud resources are provided. The method includes normalizing heterogeneous data for provider-specific resources into a normalized data model that maintains relationships between components. A service request specifying an application is received. An orchestration sequence for the application is determined by analyzing the normalized data model to identify a subset of provider-specific resources for an infrastructure and day-2 environment of the application, and generating a process workflow. The orchestration sequence is executed by configuring the subset of provider-specific resources according to the process workflow. The method enables efficient orchestration of diverse resources across heterogeneous provider environments using a unified data model and workflow generation approach.

### CROSS-REFERENCE TO RELATED APPLICATIONS

This application is related to co-pending U.S. patent application Ser. Nos. ______, ______, and ______, filed on the same day as this application, each entitled “ORCHESTRATION AND MANAGEMENT OF HETEROGENEOUS COMPUTING RESOURCES,” and associated with Attorney Docket Nos. P176275US, P176276US, and P176278US, respectively, which applications are hereby incorporated by reference herein in their entirety.

### BACKGROUND

Cloud computing has revolutionized the way organizations manage and deploy IT resources. By providing on-demand access to a shared pool of configurable computing resources, cloud platforms enable organizations to rapidly scale their infrastructure and services without needing large upfront investments in hardware. These resources can include virtual machines, storage, networking, databases, and various software applications and services.

The cloud computing model typically encompasses several service categories, including Infrastructure as a Service (IaaS), Platform as a Service (PaaS), and Software as a Service (SaaS). IaaS provides virtualized computing resources over the internet, allowing users to rent virtual machines, storage, and networking. PaaS offers a platform for developers to build, run, and manage applications without the complexity of maintaining the underlying infrastructure. SaaS delivers software applications over the internet, eliminating users needing to install and run the applications on their computers or infrastructure.

As cloud adoption has grown, many organizations have embraced hybrid and multi-cloud strategies. Hybrid cloud environments combine public and private cloud resources, allowing businesses to keep sensitive data on-premises while leveraging the scalability and cost-effectiveness of public clouds for other workloads. Multi-cloud approaches involve using services from multiple cloud providers, which can help avoid vendor lock-in and optimize for specific capabilities offered by different platforms.

The management and orchestration of resources across diverse cloud environments can present significant challenges for organizations. Various tools and platforms have emerged to address these challenges. However, the rapidly evolving nature of cloud services and the increasing complexity of enterprise IT landscapes continue to present ongoing challenges in this domain.

### BRIEF DESCRIPTION OF THE DRAWINGS

For a more complete understanding of this disclosure, and advantages thereof, reference is now made to the following descriptions taken in conjunction with the accompanying drawings.

FIG. 1 is a block diagram of a cloud computing management environment, according to some implementations.

FIG. 2 is a block diagram of hardware components of the management platform, according to some implementations.

FIG. 3 is a block diagram of the software architecture of the management environment, according to some implementations.

FIG. 4 is a block diagram of a management method, according to some implementations.

FIG. 5 is a flowchart of a plugin method, according to some implementations.

FIG. 6 is a flowchart of an orchestration method, according to some implementations.

FIG. 7 is a flowchart of a data normalization method, according to some implementations.

FIG. 8 is a flowchart of an application deployment method, according to some implementations.

FIG. 9 is a flowchart of a data normalization method, according to some implementations.

FIG. 10 is a flowchart of an orchestration method, according to some implementations.

FIG. 11 is a flowchart of a plugin method, according to some implementations.

FIG. 12 is a flowchart of an application deployment method, according to some implementations.

Corresponding numerals and symbols in the different figures generally refer to corresponding parts unless otherwise indicated.

### DESCRIPTION

The following disclosure provides many different examples for implementing different features. Specific examples of components and arrangements are described below to simplify the present disclosure. These are, of course, merely examples and are not intended to be limiting.

Modern enterprise IT environments often encompass a complex array of heterogeneous computing resources spanning multiple cloud providers, on-premises infrastructure, and various software-as-a-service offerings. Managing and orchestrating these diverse resources presents significant challenges for organizations. Different providers typically have their own proprietary interfaces, data models, and management tools, making it difficult to achieve a unified view and consistent management approach across the entire IT landscape of an organization.

This disclosure describes a system for normalizing heterogeneous data from diverse provider-specific resources into a unified data model. The normalized data model maintains relationships between components to represent dependencies across different resources, regardless of origin. By transforming provider-specific definitions into standardized schemas, the system provides a common language for describing and managing resources from any provider.

The normalized data model may be stored in a database using the defined schemas, allowing for efficient retrieval and management of resource information. This storage approach may enable the system to maintain a consistent representation of heterogeneous resources across different providers. In some aspects, the normalized data model may enable the system to provide self-service workflows, allowing end-users to request and provision resources within predefined limits. When a service request is received, the system may analyze the normalized data model to identify the provider-specific resources called for by the request. An orchestration process may be performed, based on the normalized data, to handle the service request.

The normalized data model may allow the system to intelligently orchestrate resources across heterogeneous environments. When a service request is received, the system can analyze the normalized data to identify the specific subset of resources required to fulfill the request. It then maps the dependencies between these resources to generate an optimized process workflow. This workflow considers the relationships and constraints represented in the normalized model, ensuring that resources are provisioned and configured in the correct order and with proper consideration of their interdependencies.

The normalized data model may also increase the flexibility and extensibility of the system through a plugin architecture. By generating standardized plugin interfaces for different service providers, the system allows for easy integration of new resource types and providers. These plugins manage the provider-specific interactions to configure and manage resources while the core system operates on the normalized data model. This approach enables organizations to easily adapt to new technologies and services without overhauling their management infrastructure.

The normalized data model may allow the system to provide application-centric resource management. Rather than limiting the focus on individual infrastructure components, the system can work with high-level application requirements and translate them into the requisite infrastructure and operational environment. This includes the initial provisioning of resources and also the configuration of day-2 operations such as financial operations, monitoring, backup, and scaling. By maintaining awareness of the full application context, the system can make intelligent decisions about resource allocation and management throughout the application lifecycle. An orchestration process may be performed, based on the normalized data model, to handle a service request specifying an application.

By providing a unified approach to managing heterogeneous resources, this system significantly improves IT operational efficiency. It reduces the complexity of managing multi-cloud and hybrid environments, enables more rapid and reliable service delivery, and provides greater visibility into resource utilization and dependencies. The normalized data model and intelligent orchestration capabilities enhance an organization's ability to optimize resource allocation, improve security and compliance, and quickly adapt to changing business needs. Overall, the system addresses the core challenges of modern IT infrastructure management, enabling organizations to harness the full potential of diverse computing resources while minimizing operational overhead.

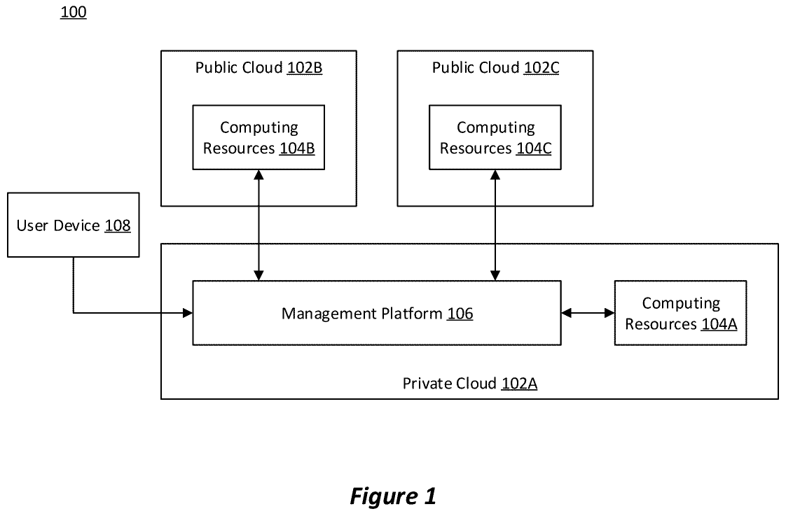

FIG. 1 is a block diagram of a cloud computing management environment 100, according to some implementations. The management environment 100 may include multiple clouds 102 (including a private cloud 102A and one or more public clouds 102B, 102C), a management platform 106, and a user device 108. This architecture represents a hybrid cloud approach for an organization, combining private and public cloud resources under centralized management while maintaining data privacy and security.

The private cloud 102A may be a privately accessible computer network under the organization's control. In some aspects, it may provide dedicated computing resources and infrastructure that are not shared with other organizations. The private cloud 102A may offer enhanced security and customization options compared to public cloud offerings. In some cases, it may allow the organization to maintain sensitive data and critical workloads on-premises while still leveraging cloud technologies and architectures. The private cloud 102A may be managed and operated by the organization's IT staff, providing greater control over resource allocation, security policies, and compliance measures.

The public clouds 102B, 102C may be publicly accessible computer networks operated by cloud providers. In some aspects, they may provide shared computing resources and infrastructure that can be utilized by multiple organizations. The public clouds 102B, 102C may offer organization's scalable and on-demand access to computing power, storage, and various services. In some cases, they may allow organizations to rapidly provision resources without large upfront investments in hardware and infrastructure. The public clouds 102B, 102C may be managed and operated by third-party cloud service providers, offering services and APIs for resource allocation and management. In some implementations, they may provide built-in redundancy and geographic distribution of resources to enhance reliability and performance. The public clouds 102B, 102C may be operated by different service providers, allowing organizations to leverage the unique strengths and capabilities of multiple cloud platforms.

The clouds 102 include computing resources 104 (e.g., computing resources 104A, computing resources 104B, and computing resources 104C for, respectively, the private cloud 102A, the public cloud 102B, and the public cloud 102C). The computing resources 104 may comprise various types of resources that can be utilized to perform computational tasks, store data, and the like. In some aspects, these resources may include virtual machines, containers, serverless functions, storage volumes, databases, networking components, and other cloud-based services. The computing resources 104 may be dynamically scalable, allowing for flexible allocation based on demand. In some cases, the computing resources 104 may include specialized hardware such as GPUs for machine learning tasks or FPGAs for custom acceleration. The computing resources 104 may also encompass platform services like managed Kubernetes clusters, serverless platforms, or IoT device management systems. Additionally, the computing resources 104 may include software-defined infrastructure components that can be programmatically controlled and configured. The specific types and configurations of computing resources 104 may vary between the private cloud 102A and public clouds 102B and 102C, reflecting the different capabilities of each environment.

The management platform 106 may serve as the central control point in the management environment 100, coordinating interactions between the various components (including the computing resources 104). In some implementations, the management platform 106 may be deployed within the private cloud 102A. In other implementations, the management platform 106 may be deployed within another part of an organization. The management platform 106 may control the computing resources 104A within the private cloud 102A and the computing resources 104B, 104C in the public clouds 102B, 102C. Specifically, the management platform 106 may send instructions to and receive information from the computing resources 104, which may allow for efficient allocation and management of resources across the clouds 102.

In some cases, the hybrid architecture of the management environment 100 may enable the organization to maintain sensitive workloads and data within their private cloud 102A while leveraging the scalability and cost-effectiveness of public clouds 102B, 102C for other operations. The management platform 106 may provide a unified view of the computing resources 104, regardless of location, allowing for consistent policies and management practices across the entire environment.

The user device 108 may be connected to the management platform 106, allowing users to interact with and control the management platform 106. This may enable administrators to manage computing resources 104 across private and public clouds from a single interface, streamlining operations and reducing complexity. This may also enable end-users (e.g., non-administrators) to access computing resources 104 as permitted by their roles and permissions. Specifically, the management platform 106 may provide self-service capabilities for end-users to provision and manage resources within defined policies and limits set by administrators.

The management platform 106 may provide a unified view of resources across multiple cloud providers and on-premises infrastructure. This unified view may allow an administrator using a user device 108 to monitor and manage the computing resources 104 across the private cloud 102A and public clouds 102B, 102C from a single interface. In some aspects, the management platform 106 may aggregate data from various sources and present it in a consistent, normalized format, enabling users to easily compare and analyze resource utilization across different environments. The normalization process may involve transforming definitions for provider-specific computing resources 104 into defined schemas, creating a standardized representation of diverse resource types. This transformation may allow the management platform 106 to handle heterogeneous data from different cloud providers and on-premises systems uniformly. The defined schemas may capture the requisite attributes and relationships of resources, enabling the platform to maintain a coherent view of the entire infrastructure landscape. By normalizing the data, the management platform 106 may facilitate cross-provider comparisons, simplify resource management tasks, and provide a foundation for advanced analytics and optimization strategies.

In addition to unified visibility, the management platform 106 may offer unified control of the computing resources 104. The platform may leverage APIs provided by the computing resources 104 to enable centralized management and orchestration. This unified control may allow administrators to perform actions such as provisioning, scaling, and configuring resources across multiple environments from a single point of control. The management platform 106 may abstract away the particularities of individual provider interfaces, presenting a consistent set of management operations that can be applied across heterogeneous computing resources 104. This unified control approach may streamline operations, including orchestration and day-2 operations.

The management platform 106 may discover and inventory computing resources 104 across the clouds 102. This discovery process may involve periodic scanning and synchronization to maintain an up-to-date view of available resources. The platform may automatically detect new resources, changes to existing resources, and resource removals across both private cloud 102A and public clouds 102B, 102C. The discovered computing resources 104 may be mapped to a normalized data model (subsequently described) for the platform, enabling consistent representation regardless of the source cloud. The discovery process may capture detailed metadata about computing resources 104, including relationships between resources, configuration settings, and operational state. This comprehensive resource discovery may enable the management platform 106 to maintain an accurate inventory of infrastructure components and their dependencies across the entire management environment 100.

The management platform 106 may manage user access and authentication within the system. This functionality may allow administrators to control the resources and capabilities end-users can access through the user devices 108. The platform may implement role-based access control (RBAC) to define and manage user permissions across the entire management environment 100, ensuring that users are limited to having access to the resources and functions appropriate for their roles. In some implementations, the management platform 106 may layer a user authentication and authorization framework over existing frameworks (if any) of the computing resources 104. For example, the management platform 106 may have a master API key to a computing resource 104 and may control how the computing resources 104 are accessed by users based on its own authentication and authorization system. The platform may map user identities and roles across different systems, providing a unified access model that spans heterogeneous environments. In some cases, the management platform 106 may integrate with existing authentication systems, enabling single sign-on capabilities.

The management platform 106 may implement a comprehensive security and compliance framework across the management environment 100. This framework may include automated security scanning of computing resources 104, continuous compliance monitoring, and policy enforcement during resource provisioning and management. The platform may integrate with security tools and services to perform vulnerability assessments, configuration audits, and security monitoring of resources across clouds 102. In some implementations, the management platform 106 may enforce security policies during provisioning, automatically configuring security controls and validating compliance requirements as resources are deployed. The platform may maintain audit trails of actions performed on computing resources 104, enabling organizations to track changes and demonstrate compliance with security requirements. Security policies may be defined and enforced consistently across the private cloud 102A and the public clouds 102B, 102C, ensuring uniform security controls regardless of resource location.

The management platform 106 may provide self-service capabilities to users of the user device 108. A user may request and provision resources through a user device 108 within predefined limits and policies set by administrators. In some aspects, the management platform 106 may present different interfaces or options to users based on their roles or permissions, allowing for customized self-service experiences while ensuring compliance with organizational policies. The self-service capabilities may be constrained by configuration settings defined within the management platform 106 by the organization. For example, administrators may set resource quotas, cost thresholds, or approved computing resources 104 that limit what users can provision. The management platform 106 may enforce these constraints automatically when processing self-service requests. Additionally, the management platform 106 may provide approval workflows for certain requests requiring additional authorization before provisioning. This allows organizations to enable user-driven provisioning while maintaining appropriate governance and control over resource usage. The platform may support contextually aware deployments, considering user permissions and group participation when determining where and how to provision resources.

The management platform 106 may implement an application-centric approach to resource management, allowing for the orchestration of complete application stacks rather than individual infrastructure components. This approach may allow users to request and manage entire applications, with the platform automatically determining and provisioning suitable computing resources 104 for the application across appropriate clouds 102, as specified by organizational policies and system configurations. The management platform 106 may maintain application context throughout the resource lifecycle, understanding relationships between application components and their supporting infrastructure. In some implementations, the management platform 106 may provide application-level monitoring, scaling, and lifecycle management capabilities. This application-centric model may abstract away infrastructure complexity, allowing users to focus on orchestrating and managing applications while the platform handles the orchestration of underlying resources and day-2 aspects. The management platform 106 may track application dependencies and requirements, using this information to make intelligent decisions about resource placement and configuration across the private cloud 102A and public clouds 102B, 102C.

The management platform 106 may provide streamlined lifecycle management of applications, from initial deployment through scaling and updates. This may include capabilities for monitoring application performance, automating scaling operations, and managing updates or patches. Users may be able to manage the entire application lifecycle through a user device 108, with the management platform 106 coordinating the requisite actions across the relevant computing resources 104 in the private cloud 102A or public clouds 102B and 102C.

The management platform 106 may integrate with various external tools and services that support the computing resources 104. These integrations may include IP address management (IPAM) systems for network address allocation, load balancers for traffic distribution, monitoring tools for performance tracking, backup systems for data protection, security scanners for vulnerability detection, domain name system (DNS) providers for name resolution, and the like. The management platform 106 may coordinate with these external tools and services during orchestration and management. For example, when configuring a computing resource 104 as part of an application's orchestration, the management platform 106 may interact with an IPAM system to allocate an IP address, a DNS provider to register a hostname, and a load balancer to configure traffic routing. The platform may maintain associations between computing resources 104 and related external services throughout the resource lifecycle, ensuring proper cleanup and resource release when resources are decommissioned. These integrations may be configured at the organization level and may apply across resources in both the private cloud 102A and public clouds 102B, 102C.

The management platform 106 may provide capabilities for tracking and metering resource usage to enable cost management and optimization. This may involve collecting detailed usage data from the computing resources 104 across the clouds 102 and presenting it in a unified format. The platform may aggregate costs and bills from the various computing resources 104 to provide consolidated financial reporting. In some aspects, the management platform 106 may implement FinOps practices to align technology spending (on the computing resources 104) with business objectives of the organization. Users may access this data through a user device 108, gaining improved visibility into resource utilization and dependencies across the entire IT landscape. The management platform 106 may provide user interfaces for analyzing this data, helping users identify opportunities for cost optimization or efficiency improvements. In some cases, the platform may enable chargeback or showback reporting to allocate costs to specific business units or projects.

The management platform 106 may provide a comprehensive, provider-agnostic API that enables users to script and automate operations across heterogeneous cloud environments. This API may abstract away the differences between various cloud providers and on-premises systems, presenting a unified interface for managing computing resources 104 regardless of their location or underlying technology. Through this API, users can programmatically control all aspects of resource provisioning, configuration, and lifecycle management across the private cloud 102A and public clouds 102B, 102C using consistent commands and data structures. In some implementations, the API may support various programming languages and offer client libraries to facilitate integration with existing tools and workflows. The provider-agnostic nature of the API may allow organizations to develop portable automation scripts and tools that can operate across different cloud environments without modification, reducing vendor lock-in and enhancing flexibility in multi-cloud strategies. These programmatic interfaces may enable advanced automation scenarios, support infrastructure-as-code practices, and facilitate integration with CI/CD pipelines and other DevOps tools.

As subsequently described, the management platform 106 may normalize data from heterogeneous sources into a common data model. Example sources of data may include data from computing resources 104 across the clouds 102, financial systems, management tools, and the like. This normalization may enable the management platform 106 to orchestrate workflows that span multiple environments and domains, considering the unique characteristics and capabilities of each resource type.

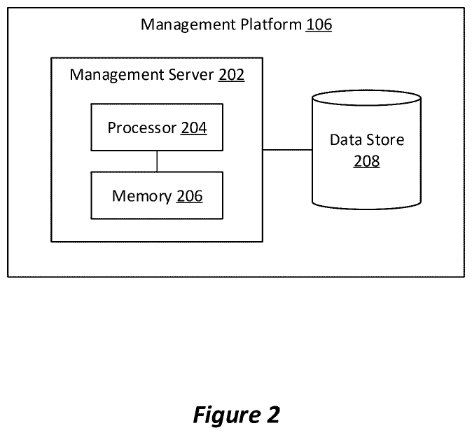

FIG. 2 is a block diagram of hardware components of the management platform 106, according to some implementations. The management platform 106 may include one or more management servers 202 and one or more data stores 208. Only one management server 202 and data store 208 are shown in this example.

In some aspects, the management server 202 may serve as the central component of the management platform 106, performing management functions. These functions may include orchestrating provider-specific resources, normalizing heterogeneous data, processing service requests, and the like.

The management server 202 may include suitable components for performing any desired functionality. One or more modules within the server may be partially or wholly embodied as software and/or hardware for performing any functionality described herein. For example, a server may include a processor 204 and a memory 206. The processor 204 may be a microprocessor, an application-specific integrated circuit, a microcontroller, or the like. The memory 206 may be a non-transitory computer-readable medium that stores instructions for execution by the processor 204. The instructions, when executed by the processor 204, may cause the processor to perform any functionality described herein.

The data store 208 may provide storage capacity for maintaining data related to the managed resources and services. In some aspects, the data store 208 may include database servers, file servers, network-attached storage (NAS) devices, or the like for storing the normalized data representing heterogeneous provider-specific resources. The data store 208 may be implemented using various storage technologies, such as relational databases, NoSQL data stores, distributed file systems, object storage, block storage, or the like depending on the specific requirements of the management platform 106.

In some cases, the management platform 106 may include redundant components or distributed architectures to provide high availability and fault tolerance. For example, the management server 202 may be implemented as a cluster of servers, with the workload distributed across multiple physical or virtual machines. Likewise, the data store 208 may be implemented using a distributed database system to ensure data redundancy and availability. The management platform 106 may also incorporate load balancing mechanisms to distribute incoming requests across multiple servers.

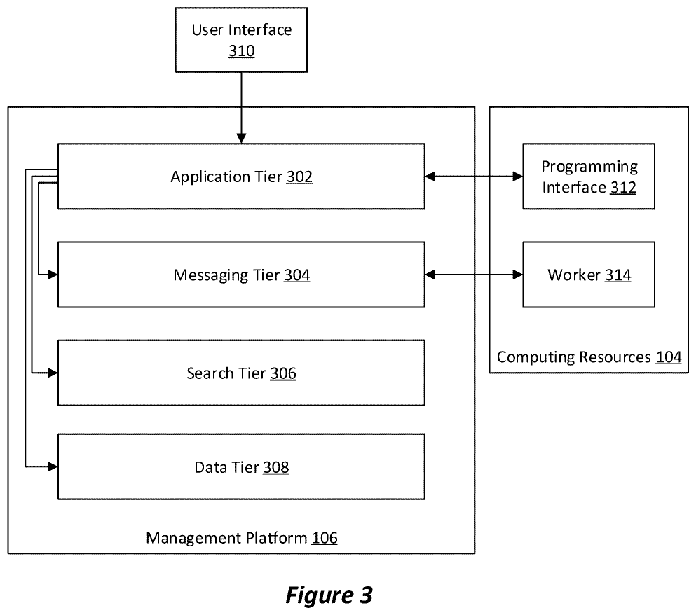

FIG. 3 is a block diagram of the software architecture of the management environment 100, according to some implementations. The diagram illustrates the various software components and tiers that make up the management platform 106 and the computing resources 104.

The management platform 106 may be implemented using a tiered architecture to organize its functionality. This architecture may include an application tier 302, a messaging tier 304, a search tier 306, and a data tier 308. The management platform 106 may include more or fewer tiers than shown in this example. The specific number and organization of tiers may vary depending on the requirements and design choices of the system.

The application tier 302 may form the core of the management platform 106, handling the primary business logic and orchestration tasks. The application tier 302 may control the other tiers within the management platform 106: the messaging tier 304, the search tier 306, and the data tier 308. In some aspects, the application tier 302 may include software applications for processing service requests, orchestrating resources, managing workflows, and the like. The application tier 302 may interact with external computing resources 104 and may coordinate activities across different cloud environments. In some implementations, the application tier 302 may be built using a microservices architecture, allowing for scalability and flexibility. The application tier 302 may leverage data stored in the data tier 308 (e.g., using a normalized data model) to make intelligent decisions about resource allocation and configuration. In some implementations, the application tier 302 may run nginx for serving a web interface, Apache Tomcat for handling business logic, and Apache Guacamole for providing remote access and control capabilities. Other applications may run in the application tier 302.

The messaging tier 304 may facilitate communication between different components of the management platform 106 and external systems. The messaging tier 304 may implement a publish-subscribe model or utilize protocols such as AMQP, running a message broker like RabbitMQ, to provide reliable and asynchronous communication between various components of the management platform 106 and computing resources 104. In some aspects, the messaging tier 304 may include a load balancer that receives messages from the application tier 302 and distributes them to message brokers.

The search tier 306 may provide indexing and search capabilities for the management platform 106. This tier may enable efficient querying and retrieval of information across the normalized data model stored in the data tier 308. In some implementations, the search tier 306 may utilize a non-transactional database such as Elasticsearch to provide high-performance full-text search and analytics capabilities. The use of Elasticsearch or similar technologies may allow for rapid searching and aggregation of large volumes of data from heterogeneous sources. This search functionality may support various operations within the management platform 106, such as resource discovery, monitoring, and reporting. The search tier 306 may index data from multiple sources, including the normalized data model, logs, and metrics, to provide a unified search interface across the entire management environment.

The data tier 308 may be responsible for data storage and management within the management platform 106. This tier may implement a normalized data model that represents the heterogeneous provider-specific resources in a standardized format. In some aspects, the data tier 308 may utilize a transactional database (such as MySQL, PostgreSQL, or the like) to store and manage the normalized data. Using a transactional database may provide Atomicity, Consistency, Isolation, and Durability (ACID) properties, ensuring data integrity and reliability. This may be particularly important when dealing with complex relationships and dependencies between heterogeneous resources. The data tier 308 may handle database operations such as inserting, updating, and querying the normalized data, providing a consistent and reliable data layer for the other tiers of the management platform 106.

The computing resources 104 may implement various mechanisms for interacting with the management platform 106. A programming interface 312 may provide programmatic access to the platform's functionality. The programming interface 312 may represent an API provided by a cloud provider, enabling the management platform 106 to interact with and control resources in that provider's environment. When the management platform 106 interacts with the computing resources 104 via a programming interface 312, the application tier 302 may directly access the programming interface 312, such as via web API requests.

A worker 314 may be executed in the computing resources 104 (e.g., potentially installed by an administrator) and may interact with the management platform 106 through messaging. The worker 314 may be a custom application executing in the cloud provider's environment. In some cases, the worker 314 may process tasks or messages and facilitate interactions between the management platform 106 and the specific cloud environment by sending information to the management platform 106. For example, the management platform 106 may interact with the computing resources 104 by sending messages to the worker 314 via the messaging tier 304.

The management platform 106 may provide a user interface 310, serving as the entry point for user interactions with the system. The user interface 310 may connect directly to the application tier 302, allowing users to initiate management and orchestration tasks, view resource status, and access other platform features.

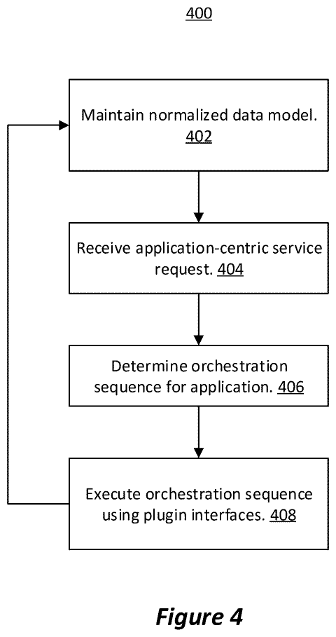

FIG. 4 is a block diagram of a management method 400, according to some implementations. The management method 400 will be described in conjunction with the management environment 100 of FIGS. 1-3. The management method 400 may be used for orchestrating heterogeneous cloud resources through a normalized data model. The management method 400 may be implemented in the management environment 100. Specifically, the management platform 106 may perform the management method 400.

At step 402, the management platform 106 maintains a normalized data model of heterogeneous data from the provider-specific computing resources 104. The normalized data model may be built by obtaining heterogeneous data from various providers, which data is then normalized into the normalized data model. For example, the management platform 106 may perform data normalization in the application tier 302. In some implementations, the normalizing of the heterogeneous data is performed by the management platform 106. The normalization process transforms diverse definitions of computing resources 104 into defined schemas representing relationships and dependencies across different computing resources 104, regardless of origin. Thus, the management platform 106 has a common format for describing and managing computing resources 104 from any provider.

For example, the normalization process can include converting various configurations (of virtual machines, IP address managers, etc.) into common formats that generically represent the configurations. For example, the management platform 106 may convert VMware-specific virtual machine attributes, AWS-specific instance properties, or InfoBlox IPAM configurations into their respective common representation. In the case of resource allocation, what may be called a resource pool in VMware, a VPC in Amazon, or a resource group in Azure, can be normalized into a common representation in the data model. The normalization may preserve provider-specific features while maintaining common denominator functionality across providers. Continuing the previous example, configurations of an IP address management tool like InfoBlox can be normalized such that network resources work seamlessly with network configurations from various cloud providers without requiring custom integration code for each combination.

The normalized model maintains relationships between components while preserving provider-specific capabilities, enabling cross-service interactions through common data abstractions. The model tracks relationships between applications and supporting infrastructure, enabling services that don't natively know about each other to interact through the normalized data model. The normalization allows the system to represent, for example, a virtual machine and a container in a common format, facilitating the management of resources across different technological paradigms through a common abstraction layer.

The normalized data model is stored in a database. For example, the management platform 106 may store the normalized data in the data tier 308. The stored model captures resource relationships, dependencies, and configurations in a format that can be efficiently queried and updated by the application tier 302. The data tier 308 may leverage a transactional database to maintain data integrity across the normalized representations. The transactional database schema includes tables that normalize infrastructure components and their relationships in the management environment. For example, a virtual machine may be represented in one table and the virtual machine's network card may be represented in another table, with the network card's IP address and connected switch tied off in related tables through the normalized data model. The structure tracks relationships and dependencies across heterogeneous resources while maintaining data consistency.

The data tier 308 interacts with the application tier 302 through database operations for storing and retrieving normalized data. The messaging tier 304 coordinates communication between the data tier 308 and other components through, for example, message queues, enabling asynchronous data operations. The search tier 306 may utilize a non-transactional database, such as Elasticsearch, to index the normalized data, enabling high-performance searching and aggregation across the normalized model.

The search tier 306 provides indexing and search capabilities across the normalized data model stored in the data tier 308. This enables efficient querying and retrieval of information about resources, relationships, and configurations stored in the data tier 308. The search functionality, provided by the search tier 306, supports various operations within the management platform 106, such as resource discovery, monitoring, and reporting.

At step 404, a service request for application deployment is received through, for example, a user or programming interface. In some aspects, the management platform 106 may provide self-service capabilities, allowing end-users to request and provision applications. The application tier 302 may receive the service request through the user interface 310. The service request may specify application requirements that span multiple provider-specific resources. Using the normalized data model maintained at step 402, the management platform 106 can process the application deployment request based on the request's context, such as whether the request comes from a QA department or production environment.

Thus, the management platform 106 implements an application-centric approach to resource management, allowing for the self-service orchestration of complete application stacks rather than individual infrastructure components. This approach allows end-users to request and manage entire applications, with the platform automatically determining and provisioning suitable computing resources for the application across appropriate clouds, as specified by organizational policies and system configurations. For example, a service request may request deployment of a multi-tier application. Based on the normalized data model, organization policies, and configurations, the management platform 106 may determine requisite compute resources to deploy the requested application. For example, the management platform 106 may form an orchestration plan that specifies compute resources from VMware, a network configuration via InfoBlox, and a load balancer configuration. In another example, a request may specify deploying a WordPress application, which requires the management platform 106 to identify and coordinate components, including web servers, database servers, storage, and network configurations. When deploying a web application, the request may specify requirements for a web server and a database server, where the database server is to be provisioned before the web server due to dependency requirements. The normalized data model enables the management platform 106 to deploy components in a way that makes them work together even though they don't natively know about each other.

At step 406, the management platform 106 determines an orchestration sequence to handle the service request. The requests are processed through the normalized data model to identify the requisite resources and dependencies. The normalized model enables the management platform 106 to understand the requisite individual resources and their relationships and dependencies across different providers. Organization policies and the end-user's request context may also influence orchestration.

The management platform 106 determines resource placement and configuration based on the application context and organizational policies. For example, the same application service request might result in different resource allocations and configurations depending on whether it's for development, testing, or production use. This may include deploying to specific cloud providers or resource pools based on the requesting group's role or applying different backup, monitoring, and security policies based on the deployment context. For example, when a QA team requests a testing environment, the management platform 106 may deploy resources to a lower-cost environment with different performance characteristics than a production deployment request from an operations team. The normalized data model allows contextual deployment by enabling different orchestration workflows to be seamlessly created and executed for each deployment environment or context transparently to the end-user.

The normalized data model enables the platform to maintain contextual differences using the same underlying resource definitions and relationships. In some aspects, the normalized model may transform complex orchestration processes into automated workflows. What traditionally requires multiple teams and extended timeframes can potentially be orchestrated as an automated sequence completed in minutes through the management platform 106.

At step 408, the management platform 106 executes the orchestration sequence. The orchestration may leverage the messaging tier 304 to coordinate actions across distributed resources. The normalized data model can enable the management platform 106 to sequence operations, such as allocating IP addresses before configuring network interfaces or deploying database instances before web servers. The orchestration process may include configuring day-2 operations such as backups, compliance automation, and security scan schedules.

The management platform 106 may utilize programming interfaces 312 and/or worker 314 within the computing resources 104 to orchestrate provider-specific resources in manners expected by each provider. For example, a worker 314 may receive commands from the management platform 106 through the messaging tier 304 to execute provider-specific operations. When provisioning resources, the worker 314 may create a secure connection back to the management platform 106 and establish a command bus for coordinating actions between the platform and provider environments. The worker 314 can operate behind load balancers for scalability and to process cloud API requests from remote locations.

The management platform 106 utilizes a plugin architecture that generates plugin interfaces for service providers. The plugin architecture may create code templates with predefined integration points, allowing providers or end-users to implement their specific functionality while maintaining consistent interaction with the normalized data model. For example, an end-user may integrate an IPAM with the management platform 106 by creating a plugin for the IPAM. To create the plugin, the system can generate a code skeleton with defined methods that the provider fills in to allocate resources (e.g., IP addresses) or perform other specific operations. The orchestration sequence may be performed using the plugin interfaces.

The plugins are loaded at runtime through an isolated class loader, potentially within a JVM running in the application tier 302. Each plugin implements common interfaces that are clearly defined through Java documentation. The management platform 106 provides a context that allows plugins to call back into the platform and save data from computing resources 104 in the normalized format.

The database schema within the data tier 308 may support the plugin architecture by providing standardized ways to store and retrieve normalized data. When plugins interact with the management platform 106, they can store their data in the normalized format through defined interfaces, allowing the data to be used consistently across the platform regardless of the original provider format.

The plugin architecture enables runtime extension of computing resources 104 integration without modifying the core code of the management platform 106. Developers can use the generated plugin code templates when integrating new providers rather than writing custom integration code. The plugin framework handles the communication and data transformation between the provider-specific implementations (of the computing resources 104) and the normalized data model, allowing new integrations to leverage existing abstractions of the management platform 106.

The management platform 106 may orchestrate provider-specific resources by leveraging the normalized data model and plugin interfaces. During orchestration, the platform may invoke relevant plugins to interact with specific provider APIs or services. These plugins may translate orchestration commands from the normalized model into provider-specific API calls, allowing the management platform 106 to manage diverse resources through a unified programming interface. For example, when allocating storage, a plugin for a particular cloud provider may convert a generic storage request into the appropriate API calls for that provider's block storage service. The plugin architecture may allow the orchestration process to seamlessly integrate new providers and resource types without modifying the core orchestration logic, enhancing the platform's extensibility and adaptability to evolving cloud ecosystems.

The management platform 106 runs code from the plugins that interfaces with provider-specific APIs (e.g., VMware or InfoBlox) of the computing resources 104. At the same time, the normalized data model in the data tier 308 maintains the standardized representation of the operations. For example, a worker 314 may execute provider-specific API calls to InfoBlox when allocating an IP address. Still, the results of those API calls are transformed and stored in the normalized model, enabling other components to interact with that IP address assignment without understanding InfoBlox-specific implementations.

The orchestration process can adjust its flow based on each step's outcomes. For instance, if a call to a third-party policy API indicates additional requirements that call for extra steps in the orchestration process, the management platform 106 can inject the additional steps into the orchestration workflow. Each step in the orchestration flow has the capability of affecting subsequent steps, allowing for dynamic adaptation based on runtime conditions.

For application lifecycle management, the orchestration by the management platform 106 may include deploying various components and configuring day-2 operations. This may include deploying application code, obtaining an IP address, configuring monitoring systems, and setting up load balancer automation. When the application instance is decommissioned at the end of its lifecycle, the orchestration ensures proper cleanup, such as releasing the IP address for reuse. Throughout the application lifecycle, the process leverages the normalized data model to coordinate actions across different service providers while maintaining consistency through standardized interfaces. The management platform 106 handles both aspects of orchestration, including initial deployment and eventual teardown, providing comprehensive lifecycle management for applications across heterogeneous environments. The orchestration process through the normalized data model may transform what traditionally requires multiple teams and extended timeframes into an automated sequence of operations that may be provided in a self-service manner to end-users.

Following the orchestration operations, the normalized data model may be updated to reflect changes implemented during orchestration. In implementations, the data tier 308 performs the updating operation. For example, when an IP address is allocated during orchestration, the normalized model is updated to reflect this IP address allocation and its relationships to other resources. The updates maintain the accuracy of resource states, relationships, and configurations across the heterogeneous environment.

The search tier 306 may index the updates to enable efficient querying of the current environment. The indexing allows the management platform 106 to discover and monitor the environment, synchronizing changes to maintain an accurate inventory of infrastructure components and their dependencies. The management platform 106 can discover existing resources in the cloud and continue synchronizing any changes on a near real-time basis for provisioned resources.

The updated model can provide a foundation for subsequent orchestration operations, ensuring decisions are based on the current infrastructure state. For example, when an application instance is later modified or removed, the management platform 106 can use the updated model to understand related components that need to be reconfigured or cleaned up, such as releasing IP addresses or updating load balancer configurations. The discovery process can include monitoring installed software packages, which can be used for security scanning and compliance verification.

Maintaining, orchestrating, and updating the normalized data model establishes a continuous feedback loop where the model evolves with the infrastructure. This enables the management platform 106 to maintain consistency across heterogeneous resources while supporting complex orchestration scenarios. The normalized model allows provider-specific resources to interact through common interfaces while preserving their unique capabilities and requirements.

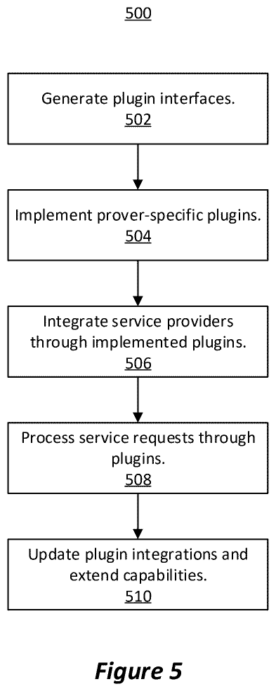

FIG. 5 is a flowchart of a plugin method 500, according to some implementations. The plugin method 500 will be described in conjunction with the management environment 100 of FIGS. 1-3. The plugin method 500 may be used for implementing a pluggable provisioning framework representing different service abstractions to manage relationships with computing resources 104. The plugin method 500 may be implemented in the management environment 100. Specifically, the management platform 106 may perform the plugin method 500.

In some aspects, the pluggable provisioning framework may enable different services (providing computing resources 104) to be integrated with the management platform 106 through standardized interfaces while maintaining the services'unique capabilities. Rather than the management platform 106 having custom integration code for each provider combination, the framework may generate plugin code templates with predefined integration points that providers or end-users can implement to interact with a desired platform through common abstractions. Thus, the management platform 106 may be extended to interact with any desired service by users through the pluggable provisioning framework.

When creating a new plugin, the management platform 106 may generate a complete source code tree, including build tooling, for the plugin. Providers or end-users may then be provided the tree, such as via a user interface 310, for modification on their user device 108. From there, users can implement provider-specific functionality through standardized interfaces in the source tree. The build tooling may then be used to compile a binary executable for the plugin, which may be loaded back into the management platform 106 via the user interface 310. During operation, the plugin may handle the implemented provider-specific operations, while the framework provided by the management platform 106 can handle common operations like authentication, state management, and data normalization. For example, an IPAM provider can implement methods for IP address allocation with a plugin, which may be loaded into the management platform 106 so that the management platform 106 can then interact with that IPAM provider. Likewise, a cloud provider can implement methods for resource management with a plugin, which may be loaded into the management platform 106.

The plugin framework can be designed to be asynchronous compatible and runtime-extensible. Plugins can be loaded dynamically through an isolated class loader within the application tier 302, enabling new providers to be added without modifying the core code of the management platform 106. The management platform 106 can maintain consistent interfaces while enabling extensibility across heterogeneous providers and resource types.

The approach enables computing resources 104 from various services to work together through common interfaces without requiring direct knowledge of each other. For instance, when a network is discovered from a cloud provider, the management platform 106 can automatically associate the cloud provider's network with an IPAM provider's pool. Subsequently, when computing resources 104 are configured in the cloud provider, they may be assigned IP addresses from the IPAM provider's pool. Thus, each provider may maintain its specific functionality while working together through the normalized data model.

At step 502, plugin interfaces for service providers are generated with standardized integration points and predefined methods. In some aspects, the management platform 106 creates the interfaces using code templates. For instance, when an IPAM plugin is generated, the management platform 106 may produce a code skeleton with defined methods that the provider can complete to allocate IP addresses or execute operations. The generated interfaces may establish common data abstractions enabling providers to implement functionality while maintaining consistent interaction with the normalized data model. The plugin architecture supports new cloud providers through the same standardized interfaces.

In some cases, the management platform 106 generates a complete source code tree to create the plugin package. The code generation may include predefined integration points where providers can implement specific functionality. For example, when constructing a plugin for a load balancer, the generated code may include standardized methods for the provider to implement, specifying how the load balancer should be interacted with. Behind the scenes, the plugin framework manages common functionality like authentication, state management, and data normalization in the management platform 106. The plugin architecture enables the same generated interfaces to be used across different integrations, such as IPAM providers, cloud providers, or load balancers, while maintaining consistent interaction patterns with the management platform 106.

The plugin interfaces generated at step 502 may include common abstractions for various service types. For instance, a cloud provider plugin may include interfaces for resource pools, network management, and compute resources. Likewise, an IPAM plugin may include interfaces for network pool management and IP address allocation. The abstractions allow the management platform 106 to interact with different providers through consistent interfaces while preserving provider-specific capabilities. The code templates generated by the management platform 106 may include build configurations that enable providers or end-users to package implementations into plugins that can be loaded by the management platform 106.

The plugin interfaces can be generated through a user interface or build tool automation. For example, a user may generate a blank plugin template via the user interface 310. The generated code may include build configurations for creating the plugin package. Once built, plugins can be loaded into the management platform 106 through a watch directory, the user interface 310, or the like. The management platform 106 may provide documentation and examples for the plugin abstractions, and completed plugins can be shared through a central repository where other users can download them with implementation instructions.

At step 504, following interface generation, provider-specific plugins are implemented using the generated interfaces and loaded at runtime. In some implementations, the management platform 106 loads the plugins through an isolated class loader within a JVM of the application tier 302. Each plugin can implement common interfaces defined through documentation, with the management platform 106 providing a context that allows plugins to call back into the platform and save data in a normalized format.

In some cases, when a plugin is loaded, the management platform 106 verifies and initializes it (e.g., using code signing verification). The plugin can then enable command communication between the management platform 106 and the computing resources 104 of provider environments. The runtime loading capability at step 504 enables plugins to be loaded while the management platform 106 operates.

At step 506, once plugins are implemented, service providers may be integrated through the implemented plugins. For example, the management platform 106 can execute the plugins to establish connections with computing resources 104 and transform provider-specific data from the computing resources 104 into the normalized format for storage in the data tier 308. The plugins can leverage existing abstractions, such as an IPAM provider using existing network configurations, without requiring large amounts of custom integration code. Integrating a new plugin can be completed quickly (potentially in several hours) to implement the predefined interface methods with the provider-specific code.

In some implementations, the integration enables providers to work together through the normalized data model without direct knowledge of each other. For example, when integrating VMware and InfoBlox, the InfoBlox plugin may manage IP addresses while the VMware plugin can discover networks managed via the InfoBlox plugin, with the management platform 106 maintaining the associations between the plugins and resources. These associations may allow an orchestration process to automatically handle operations like allocating IP addresses for newly discovered networks. Continuing the previous example, when a new virtual machine is created with VMware, the management platform 106 can leverage the plugins and normalized data model to obtain an IP address from InfoBlox and provide it to the VMware VM, even though VMware has no direct knowledge of InfoBlox or where the IP address originated. The management platform 106 may act as an intermediary, using the normalized representations to coordinate actions between the VMware and InfoBlox plugins without requiring either plugin to have specific knowledge of the other's implementation details.

The plugin integration at step 506 enables consistent representation of resources across different providers. For example, resource pools can be represented uniformly whether they come from VMware as resource pools, Amazon as VPCs, or Azure as resource groups. The normalized model maintains consistent representations while preserving provider-specific attributes, allowing the management platform 106 to provide a unified interface while retaining full provider functionality, with the plugins used to control desired computing resources 104 of providers.

As providers are integrated through the implemented plugins, the plugins may actively discover computing resources 104 from the service providers. During this process, the plugins transform provider-specific data into the normalized format used by the management platform 106, using plugin code provided by users or cloud providers. This transformation may involve mapping provider-specific attributes to standardized fields, abstracting provider-specific concepts, and establishing relationships between resources. For example, when a cloud provider plugin discovers a virtual machine, it may extract details such as CPU, memory, and network configurations, translating them into the normalized model. The ongoing discovery and normalization process enables the management platform 106 to maintain an up-to-date, unified view of resources across heterogeneous environments without changing to its core functionality.

At step 508, with providers integrated, service requests are processed through the plugins. In some implementations, the core binaries of the management platform 106 send commands to execute the appropriate plugin software. Commands can be sent back and forth asynchronously between the core binaries of the management platform 106 and the plugins. The plugins can perform cloud API requests to providers in remote locations. For example, when allocating an IP address, a plugin can execute provider-specific API calls to an IPAM, and the results are transformed and stored in the normalized model, enabling other components to interact with that IP address assignment without knowledge of how the IP address was assigned or how the IP address should be freed.

In some cases, when processing operations, plugins can interface with provider-specific APIs while the normalized data model maintains standardized representations. For example, when a cloud provider discovers a network, an IPAM pool can be associated with that network. The management platform 106 can orchestrate operations across the associated resources without requiring the plugin for either provider to know the other's implementation details.

At step 510, as the environment evolves, plugin integrations may be updated and capabilities extended at runtime. In some implementations, the management platform 106 enables runtime extension of provider integrations without modifying core platform code. The plugin architecture can add new provider implementations, and provider relationships can be maintained through the normalized data model in the data tier 308. The normalized model enables plugins to interact without direct knowledge of each other, allowing services to work together through common or standardized interfaces. The management platform 106 can discover and monitor the environment, synchronizing changes periodically to maintain an accurate inventory of infrastructure components and their dependencies.

When a new service provider is added to the management environment, new plugins may be created to integrate the provider's specific functionality into the management platform 106. The management platform 106 may generate a plugin interface template for the new provider, which may include predefined integration points and standardized methods. Developers may implement the provider-specific logic within this template, ensuring compatibility with the existing normalized data model. Once implemented, the new plugin may be compiled and loaded into the management platform 106 at runtime, potentially without requiring a system restart. The plugin may enable the management platform 106 to interact with the new provider's resources, transforming provider-specific data into the normalized format used by the platform. This approach may allow for the seamless integration of new service providers, maintaining the flexibility and extensibility of the management environment while preserving the unified interface for resource management across diverse providers.

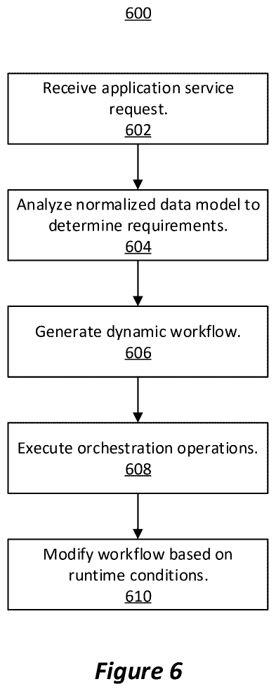

FIG. 6 is a flowchart of an orchestration method 600, according to some implementations. The orchestration method 600 will be described in conjunction with the management environment 100 of FIGS. 1-3. The orchestration method 600 may be used for orchestrating operations across multiple service domains by leveraging a normalized data model to understand relationships and dependencies between components. The orchestration method 600 may be implemented in the management environment 100. Specifically, the management platform 106 may perform the orchestration method 600.

The orchestration method 600 automatically sequences and executes operations based on discovered relationships and application requirements, as reflected in its normalized data model. For example, when deploying a multi-tier application, the orchestration method 600 may determine that certain components (e.g., a database server) need to be provisioned and operational before others (e.g., a web server) due to dependency relationships. The method may execute through different phases of provisioning (e.g., pre-provision, provision, and post-provision), with each phase potentially involving multiple computing resources 104 that do not directly interact but can work together through the normalized model.

The orchestration may dynamically adapt its workflow based on runtime conditions. As the workflow progresses, the outcomes of operations may indicate additional requirements, which may be automatically injected into the process. For example, one process of the workflow may complete, but indicate that a security scan should be performed after its completion; based on this, the orchestration flow may be modified to include that security scan. This dynamic adaptation may extend throughout the resource lifecycle, from initial provisioning through day-two operations like backup configuration and monitoring to eventual cleanup operations when computing resources 104 are decommissioned.

At step 602, an application service request is received. The application tier 302 may receive the request through the user interface 310. The service request may specify application requirements that span multiple domains. For example, a request for deploying a web application may require a web server and a database server. The management platform 106 may process these requests based on the normalized data model and the context of the service request, such as the desired environment or purpose.

The management platform 106 may deploy computing resources 104 differently based on the requesting entity and deployment context. The same application service request may result in different resource allocations and configurations depending on factors such as the intended use, performance requirements, or cost constraints. For example, a request for a testing environment may result in deployment to a lower-cost environment with different performance characteristics compared to a production deployment request. Accordingly, the same application service request can result in different resource allocations and configurations depending on the context of the service request. This may include deploying to specific cloud providers or resource pools based on the context.

The service request may specify requirements for deploying complex applications. This may require the management platform 106 to identify and coordinate requisite computing resources 104, including various types of servers, storage, and network configurations. The normalized data model may enable the management platform 106 to manage the resources to work together even if they do not natively interact. The management platform 106 may determine the appropriate sequence for deploying these components based on the dependencies.

At step 604, following receipt of the service request, the normalized data model is analyzed to determine application requirements. The management platform 106 may use the normalized model to identify computing resources 104 for the request and map dependencies between components. For example, when deploying a multi-tier application, the platform can determine that a database server needs to be provisioned before a web server due to dependency requirements. The relationships may be maintained in the normalized model regardless of whether components reside in different environments.

The management platform 106 may analyze the normalized data to identify the specific subset of computing resources 104 required to fulfill the request. For example, when a provider discovers a network resource, the management platform 106 may identify whether additional resources or configurations need to be associated. The normalized model may enable the platform to understand the requisite individual computing resources 104 and their relationships and dependencies across different providers, allowing for proper orchestration sequencing.

The analysis may include identifying components affected by the service request. The normalized model may allow different components to be understood in a common format, enabling the platform to determine how they interact and depend on each other, regardless of the origin provider. The analysis can form the basis for generating an orchestration process workflow in subsequent steps.

At step 606, a dynamic workflow is generated based on the analyzed requirements and mapped dependencies. The management platform 106 may create a process workflow based on the relationships identified at step 604. The workflow may include operations across different computing resources 104, with sequential requirements determined from the dependency analysis.

Workflow generation may include determining the correct sequence of operations based on component dependencies. The management platform 106 may generate a chain of process events for deploying the requested application. The workflow may also include configuring ongoing operations such as backups, compliance automation, and security scans.

The workflow generation may consider the application context identified in previous steps. For example, when generating workflows for different environments, the process flow may include different steps or configurations while maintaining the same basic dependencies. Each step in the generated workflow may maintain awareness of its relationships to other steps, enabling proper sequencing of operations.

At step 608, orchestration operations are executed using the workflow generated at step 606. The management platform 106 may coordinate actions across service domains (e.g., different providers of the computing resources 104), following the process sequence established in the workflow. The services may be configured in tandem by the management platform 106 through the normalized data model despite not directly interacting with each other.

The orchestration process may execute operations through a series of phases. For example, resource allocation may be performed during the pre-provisioning phase, followed by the main provisioning phase, and then post-provisioning operations. The pre-provisioning phase may include allocating network resources (e.g., IP addresses), configuring DNS, setting up load balancer configurations, and the like. The provisioning phase may include package deployment and installation. Post-provisioning operations can include configuring backups, setting up monitoring, and implementing security scan schedules. Throughout the phases, the management platform 106 may maintain the state and ensure proper execution of each step.

Executing operations may leverage the normalized data model to coordinate between different services. For example, when a network is needed to create a virtual machine in VMware, it can be automatically associated with an InfoBlox-managed IP pool. The platform may allocate resources across different providers without requiring them to have direct knowledge of each other. This may enable operations that traditionally employed multiple teams and manual handoffs to be automated into a single orchestration workflow.

At step 610, during the execution of operations from step 608, the workflow may be modified based on runtime conditions. The management platform 106 may inject additional process steps into the deployment workflow when called for. For example, if a call to an external API indicates additional requirements, these steps may be added to the workflow. When computing resources 104 are decommissioned, the workflow may handle cleanup operations, such as releasing allocated resources (e.g., IP addresses) for use by other components.

In implementations of step 610, each step in the orchestration flow may affect subsequent steps. As the workflow progresses, integrations may indicate that additional steps are needed. The management platform 106 may adjust the flow by injecting these new requirements into the process, allowing for dynamic adaptation based on runtime conditions.

The modification process may ensure proper resource management throughout the application lifecycle. For example, when an application instance is deleted, the management platform 106 may use the normalized model to identify all related components that need cleanup. This can include releasing IP addresses, updating any associated load balancer configurations, and the like. These cleanup operations may be coordinated through the normalized model, maintaining environmental consistency.

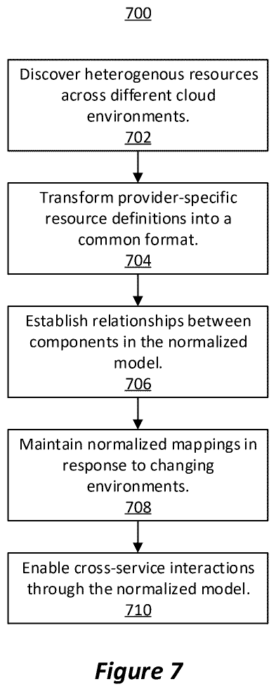

FIG. 7 is a flowchart of a data normalization method 700, according to some implementations. The data normalization method 700 will be described in conjunction with the management environment 100 of FIGS. 1-3. The data normalization method 700 may be used to provide a common representation of resources and their relationships across heterogeneous environments. Instead of managing different providers'computing resources 104 through unique interfaces and data structures, the management platform 106 transforms provider-specific definitions (using the normalized data model) into standardized schemas that maintain relationships between components/resources while preserving provider-specific capabilities. The data normalization method 700 may be implemented in the management environment 100. Specifically, the management platform 106 may perform the data normalization method 700.

The method 700 may enable resources from different providers to be managed consistently while maintaining their unique features. For example, a common abstraction in the normalized data model may represent conceptually similar resources that providers refer to by different names (e.g., resource pool, VPC, resource group). The normalized data model may employ data structures that normalize components and their relationships, allowing various services to work together through the normalized model without requiring direct knowledge of each other.

The normalized data model may serve as a structural framework and operational translation layer. It may maintain relationships between components (e.g., a virtual machine's network card, IP address, and connected switch) even when the components come from different providers. This may enable services that don't natively interact to work together. For example, one service may provide network resources while another manages addressing, with the normalized data model maintaining the associations between them.

Through normalized representation, organizations may develop consistent management practices across different environments while preserving provider-specific capabilities. The normalized data model may evolve with the infrastructure through continuous discovery and synchronization, accurately representing resources and their relationships across the heterogeneous environment.

At step 702, heterogeneous resources may be discovered across different environments (e.g., different cloud environments). The management platform 106 may discover computing resources 104 from various providers and their configurations. The discovery process may include identifying software packages installed on components that can be used for various management tasks, such as security scanning and compliance verification.

The management platform 106 may automatically detect new computing resources 104, changes to existing resources, and resource removals across different environments. When attached to a supported cloud endpoint, the management platform 106 may inventory all existing computing resources 104 at the endpoint and continue synchronizing any changes on a near real-time basis for provisioned resources. The discovery process may enable the management platform 106 to accurately inventory computing resources 104 and their dependencies.

The discovery step may include mapping the discovered resources to the normalized data model. For example, when discovering network resources from one provider, the management platform 106 may identify networks that may need to be associated with address management pools from another provider. The discovered resources may be converted to normalized resources, enabling consistent management capabilities across the platform.

At step 704, following resource discovery, provider-specific resource definitions may be transformed into a common format. The management platform 106 may convert different representations of similar resources into a normalized schema. For example, what may be called a resource pool in VMware, a VPC in Amazon, or a resource group in Azure is transformed into a common representation in the data model. The normalization may preserve provider-specific features while maintaining common functionality across providers.

The transformation process may enable cross-provider resource management through unified data structures. For example, when representing similar resources from different providers, the management platform 106 may normalize their properties while preserving provider-specific capabilities. This may allow the management platform 106 to treat conceptually similar resources uniformly in the normalized data model, facilitating management across different technological paradigms through common abstractions.

The normalization may create a common language for describing and managing computing resources 104 from any provider. Unlike tools that treat resources separately based on their provider, the normalized data model may enable consistent representation and management across providers. The normalization may allow organizations to develop portable automation and management practices that work consistently across different environments.

At step 706, using the normalized resource definitions from step 704, relationships between components may be established in the normalized data model. The management platform 106 may map dependencies and associations between resources, regardless of provider origin. The management platform 106 may create the foundational mappings that define how different components relate to each other in the normalized data model.

Relationship mapping may include tiered dependencies between components. For example, in an application deployment, the management platform 106 may establish relationships between various computing resources 104, such as storage, networking configurations, and application services. These relationships may be maintained even when components span different providers or environments. The relationships may define the proper sequencing requirements, such as one component needing to exist before its dependent components.

The relationship establishment at step 706 may create the structural foundation in the normalized data model. For example, when a resource is discovered from one provider, the management platform 106 may establish the potential association points with related resources from other providers. The relationship definitions may create the framework for how components can interact, setting up the pathways for subsequent operations. Additionally, administrators may configure these relationships, allowing for tailored interactivity between components based on specific administrative or organizational settings.

At step 708, based on the established relationships from step 706, the normalized mappings may be maintained as the environment changes. The management platform 106 may synchronize changes periodically to keep an accurate inventory of components and their dependencies. The normalized data model may be organized via data structures (e.g., tables in a database of the data tier 308) that normalize components and their relationships. That is, the tables of the database may have the defined schemas of the normalized data model.

When the management platform 106 discovers changes in computing resources 104, it may update the normalized data model to reflect the current state of the environment. The structure may enable tracking relationships and dependencies while maintaining consistency across heterogeneous resources.

The maintenance process may include continuous discovery and synchronization of the environment. For example, when new components are added to managed systems, the information may be captured in the normalized data model. The updates may enable the management platform 106 to maintain current information for various management tasks. In some aspects, the management platform 106 may poll computing resources 104 (e.g., via APIs) periodically, potentially using plugins of the management platform 106 to discover changes in the computing resources 104. The management platform 106 may then record any discovered changes in the normalized data model of the data tier 308. This process may enable the management platform 106 to maintain an up-to-date representation of the heterogeneous computing environment. The normalized data model may maintain the relationships even as resources are modified, added, or removed from the environment.

At step 710, the established relationships may enable runtime operations between services, leveraging the maintained mappings from step 708. The management platform 106 may use normalized relationships to coordinate actions between providers. The normalized data model may serve as an operational translation layer, allowing providers to work together (potentially via plugins of the management platform 106) without direct integration.

The normalized data model may facilitate active operations between services. For instance, when provisioning new resources, the management platform 106 may automatically allocate computing resources 104 from one provider based on relationships with resources from another provider. This may enable operations that traditionally employed multiple teams and manual handoffs to be automated through the normalized data model.

The operations at step 710 may extend throughout the resource lifecycle. For example, when resources are decommissioned, the management platform 106 may use the established relationships to coordinate cleanup operations across providers, such as releasing allocated computing resources 104 and updating configurations. The runtime operations may leverage the relationship framework to maintain consistency while preserving each provider's specific capabilities.

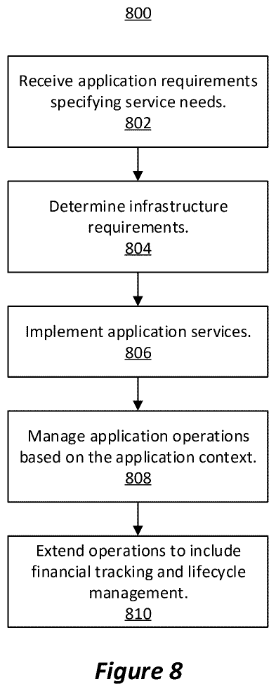

FIG. 8 is a flowchart of an application deployment method 800, according to some implementations. The application deployment method 800 will be described in conjunction with the management environment 100 of FIGS. 1-3. The application deployment method 800 may be used for orchestrating deployment in an application-centric manner, where rather than building from the ground up (e.g., starting with infrastructure components), the model begins with application requirements and determines the requisite supporting components for the application. The application-centric management approach represents a shift from traditional infrastructure-first approaches to one where applications drive resource management. The application deployment method 800 may be implemented in the management environment 100. Specifically, the management platform 106 may perform the application deployment method 800.

The normalized data model may maintain awareness of the complete application context throughout the resource lifecycle. This context may influence initial provisioning and ongoing operations like monitoring, backup, security, and financial tracking. For example, when a user requests an application, the management platform 106 may determine the requisite components, their relationships, and dependencies and orchestrate the deployment and configuration in the correct sequence. The same application context may drive how day-2 operations are configured, and resources are managed throughout the lifecycle.

The approach may enable users to focus on the application requirements while the management platform 106 handles the complexity of infrastructure and day-2 management. Furthermore, the approach may expand beyond bare provisioning to include financial operations and lifecycle management, all driven by application context rather than infrastructure components.

The method 800 implements the application-centric approach through a series of steps that transform application requirements into fully managed services. The method may coordinate the identification, implementation, and management of resources based on application context, ensuring proper sequencing and configuration throughout the application lifecycle.

At step 802, application requirements are received that specify service needs (rather than infrastructure components). The management platform 106 may process requests based on the request's context. For example, rather than requesting a specific infrastructure component, a user may request a complete application, and the management platform 106 may determine the requisite components to support the requested application. In one specific implementation, this could involve a user requesting a WordPress application instead of requesting virtual machines, a web server, and a database server.

The application requirements may specify complex application stacks rather than individual resources. This may allow the management platform 106 to automatically identify and coordinate requisite components for the application. For example, a WordPress application request might include requirements for web servers, database servers, storage, and network configurations, allowing the management platform 106 to automatically identify and coordinate all these components.

At step 804, based on the application requirements from step 802, infrastructure needs are determined through the application context. The management platform 106 may identify the complete stack of components to support the application. This may involve identifying and coordinating various types of computing resources 104 (e.g., servers, storage solutions, network configurations, etc.) based on the specific application requirements.

The management platform 106 may determine the requisite components and their relationships and dependencies. This may influence how resources are provisioned and configured, including the order in which their orchestration will occur. The management platform 106 may also determine specific provider requirements based on the application needs and available resources. For example, this could involve determining compute resources from one provider, network configuration from another, and load balancer configurations from yet another. In a more specific example, when determining the needs for a web application, the management platform 106 may identify that a database server should exist before the web server can be configured and may use that information in ordering the orchestration of those components.

The determination process may consider various contextual factors when identifying infrastructure needs. The management platform 106 may consider various contextual factors, such as the intended use or environment of the deployment. This may result in different configurations for the same application request depending on factors such as whether it's for development, testing, or production use. For instance, a QA team's request for a testing environment may specify different performance characteristics and resource allocations compared to a production deployment request from an operations team.

At step 806, application services are implemented across the infrastructure using the component requirements identified at step 804. The management platform 106 may coordinate deploying and configuring of requisite computing resources 104 based on their dependencies. The application context may drive what is provisioned and the sequence of operations for the provisioning.

The service implementation may include multiple phases of operations, which may vary based on the application's specific requirements and the infrastructure being used. These phases may include pre-provisioning operations, main provisioning operations, and post-provisioning operations. For example, operations such as IP address allocation may be performed during pre-provision. The provisioning phase may include specifying deployment metadata so a deployed operating system gets the IP address properly when it boots up. Post-provision operations may include deploying application code, configuring monitoring, and setting up load balancer automation. Each phase may involve different types of tasks and may interact with various provider-specific services as needed.

At step 808, following service implementation, application operations are managed based on the application context established in previous steps. The management platform 106 may configure various operational aspects such as backups, monitoring, and security scanning. The application context may determine the specific configuration of these operations.

The management platform 106 may continuously discover and monitor the environment, maintaining an up-to-date inventory of infrastructure components and their dependencies. This may include monitoring software packages and enabling various management capabilities such as security scanning and compliance verification.

Operations management may include handling ongoing (or day-2) operations based on the context of the application. For example, different backup policies, compliance automation requirements, and security scan schedules may be applied based on whether the application runs in development, testing, or production. When the application needs to be scaled or reconfigured, the platform may maintain awareness of the complete application context to ensure all related components are appropriately adjusted. The application-centric approach may enable operational decisions based on application requirements rather than individual infrastructure components.

At step 810, leveraging the established application context, operations are extended to include other aspects, such as financial tracking and lifecycle management. The management platform 106 may manage costs and scale at the application level rather than the infrastructure level. This may enable organizations to understand expenses and make decisions based on application needs rather than individual infrastructure components.

The management platform 106 may maintain awareness of the entire application context throughout the resource lifecycle. This may allow for efficient management of resources over time, including modifications, scaling, and eventual decommissioning. For example, when an application instance provisioned months ago needs to be modified or removed, the platform can identify all related components that need reconfiguring or cleaning up. As a more specific example, cleanup operations can include releasing IP addresses for use by other instances and updating any associated load balancer configurations. The management platform 106 may coordinate these lifecycle operations through the normalized data model, potentially without requiring direct communication between different service providers.

The extension of operations may include financial operations (FinOps) practices aligned with application contexts. This may provide organizations with application-level visibility into resource utilization and costs, enabling informed decision-making about resource allocation. For example, when tracking resource utilization and costs, the platform may provide visibility at the application level rather than be limited to showing individual resource consumption. This can enable organizations to understand the actual cost of running applications across different environments and make informed decisions about resource allocation. The application context may allow for appropriate limits and policies to be set, such as preventing development or QA environments from consuming excessive resources while ensuring production applications have the appropriate capacity. In some aspects, the platform can implement FinOps practices to align technology spending with business objectives. Users may access consolidated financial reporting and cost data through interfaces that help identify opportunities for optimization or efficiency improvements. In some cases, the platform may enable chargeback or showback reporting to allocate costs to specific business units or projects.

The management platform 106 may provide consolidated financial reporting. The management platform 106 may retrieve financial information such as bills and invoices from various computing resources 104 of different providers, potentially through those providers'APIs. This financial data may be stored in the normalized data model within the management platform 106. Users can then access a generic FinOps view that provides insights into financial metrics at the application level. This view may include detailed breakdowns of costs associated with specific applications, enabling users to understand and manage the financial aspects of their technology investments more effectively. The platform may also support integrating financial data from multiple sources into a generic view, ensuring comprehensive financial visibility across different cloud environments.

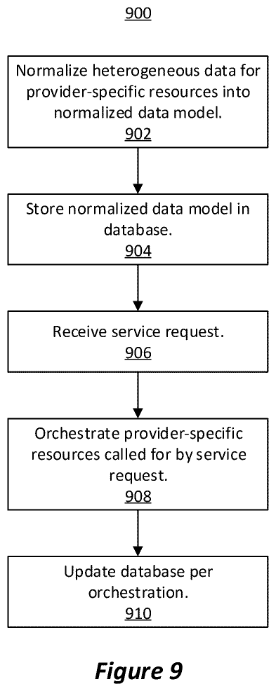

FIG. 9 is a flowchart of a data modeling method 900, according to some implementations. The data modeling method 900 will be described with the management environment 100 of FIGS. 1-3. The data modeling method 900 may be implemented in the management environment 100. Specifically, the management platform 106 may perform the data modeling method 900.

The management platform 106 may perform a step 902 of normalizing heterogeneous data for provider-specific resources (e.g., computing resources 104) into a normalized data model. This step involves transforming definitions for the provider-specific resources into defined schemas. The normalized data model maintains relationships between components to represent dependencies across the provider-specific resources.

The management platform 106 may perform a step 904 of storing the normalized data model in a database (e.g., data store 208) using the defined schemas. In some implementations, the database may be a transactional database comprising tables having the defined schemas. The data tier 308 may be used to store the normalized data model.

The management platform 106 may perform a step 906 of receiving a service request calling for a subset of the provider-specific resources. This service request may be received through the user interface 310.

The management platform 106 may perform a step 908 of orchestrating the subset of the provider-specific resources called for by the service request. This orchestration may involve coordinating actions across different cloud environments (e.g., private cloud 102A, public clouds 102B, 102C) using the normalized data model. The application tier 302 may be responsible for executing this orchestration process.

The management platform 106 may perform a step 910 of updating the database to reflect changes resulting from the orchestration of the subset of the provider-specific resources. This step ensures that the normalized data model remains current and accurate after the orchestration process.

In some implementations, the method 900 may also include indexing the normalized data model in a non-transactional database. This indexing may be performed by the search tier 306, potentially using a technology such as Elasticsearch.

The orchestration in step 908 may include mapping dependencies between the subset of the provider-specific resources to generate a process workflow based on the relationships maintained in the normalized data model. The management platform 106 may then configure the subset of the provider-specific resources according to this process workflow.

In some aspects, the management platform 106 may perform a step of generating plugin interfaces for the provider-specific resources and obtaining the heterogeneous data for the provider-specific resources using the generated plugin interfaces. The subset of the provider-specific resources may be orchestrated using these generated plugin interfaces.

When the service request specifies an application, the orchestration step 908 may involve analyzing the normalized data model to identify the subset of the provider-specific resources for an infrastructure and a day-2 environment of the application based on the relationships maintained in the normalized data model. The management platform 106 may then deploy the application by configuring the subset of the provider-specific resources, and subsequently tear down the application by reconfiguring the subset of the provider-specific resources.

In some implementations, the management platform 106 may perform a step of retrieving financial data from the provider-specific resources, transforming the financial data into a normalized cost format according to the defined schemas, and generating consolidated financial reporting based on the normalized cost format.

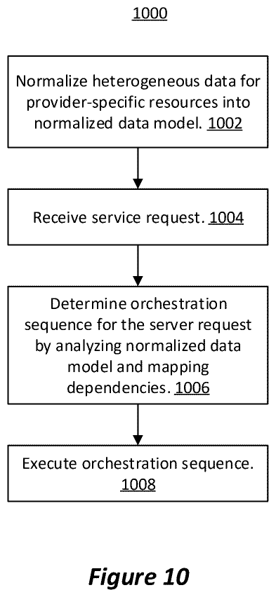

FIG. 10 is a flowchart of an orchestration method 1000, according to some implementations. The orchestration method 1000 will be described with the management environment 100 of FIGS. 1-3. The orchestration method 1000 may be implemented in the management environment 100. Specifically, the management platform 106 may perform the orchestration method 1000.

The management platform 106 may perform a step 1002 of normalizing heterogeneous data for provider-specific resources (e.g., computing resources 104) into a normalized data model. This step involves transforming definitions for the provider-specific resources into defined schemas. The normalized data model maintains relationships between components to represent dependencies across the provider-specific resources.

The management platform 106 may perform a step 1004 of receiving a service request. The service request may be associated with a context of a user and an application. In some aspects, the context may comprise a group of the user, and the context may further comprise a deployment environment of the application.

The management platform 106 may perform a step 1006 of determining, based on the service request and the normalized data model, an orchestration sequence for the service request. This step involves analyzing the normalized data model to identify a subset of the provider-specific resources called for by the service request. The management platform 106 may then map dependencies between the subset of the provider-specific resources to generate a process workflow based on the relationships maintained in the normalized data model.

In some implementations, when the service request specifies an application, determining the orchestration sequence may further comprise analyzing the normalized data model to identify the subset of the provider-specific resources for an infrastructure and a day-2 environment of the application based on the relationships maintained in the normalized data model.

The management platform 106 may perform a step 1008 of executing the orchestration sequence by configuring the subset of the provider-specific resources according to the process workflow. The subset of the provider-specific resources may be configured according to the context of the user and application.

In some aspects, executing the orchestration sequence may include modifying the process workflow when executing the orchestration sequence according to an outcome of configuring one of the provider-specific resources. Modifying the process workflow may comprise injecting a process into the process workflow.

In some implementations, the management platform 106 may also perform steps of storing the normalized data model in a transactional database (e.g., data store 208), the transactional database comprising tables having the defined schemas, and indexing the normalized data model in a non-transactional database (e.g., using the search tier 306).

The management platform 106 may also perform steps of generating plugin interfaces for the provider-specific resources and obtaining the heterogeneous data for the provider-specific resources using the generated plugin interfaces. The subset of the provider-specific resources may be configured using the generated plugin interfaces.

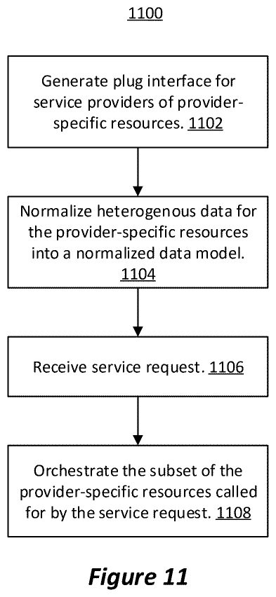

FIG. 11 is a flowchart of a plugin method 1100, according to some implementations. The plugin method 1100 will be described with the management environment 100 of FIGS. 1-3. The plugin method 1100 may be implemented in the management environment 100. Specifically, the management platform 106 may perform the plugin method 1100.

The management platform 106 may perform a step 1102 of generating plugin interfaces for service providers (e.g., clouds 102) of provider-specific resources (e.g., computing resources 104). This step allows for the integration of various service providers into the management environment 100.

The management platform 106 may perform a step 1104 of normalizing heterogeneous data for the provider-specific resources into a normalized data model. This normalization process involves transforming definitions for the provider-specific resources into defined schemas. The normalized data model maintains relationships between components to represent dependencies across the provider-specific resources.

The management platform 106 may perform a step 1106 of receiving a service request. This service request calls for a subset of the provider-specific resources. The service request may be received through the user interface 310.

The management platform 106 may perform a step 1108 of orchestrating the subset of the provider-specific resources called for by the service request. This orchestration step uses the generated plugin interfaces and the normalized data model to coordinate the necessary resources. The plugin interfaces manage interactions with the service providers to configure the provider-specific resources.

In some implementations, the management platform 106 may also perform a step (not separately illustrated) of obtaining the heterogeneous data for the provider-specific resources using the generated plugin interfaces. This step may involve using the plugin interfaces to communicate with various service providers and retrieve data about their resources.

In some aspects, the management platform 106 may load the plugin interfaces dynamically at runtime through an isolated class loader. This dynamic loading allows for flexibility in adding or updating plugin interfaces without requiring system restarts.

The step 1102 of generating the plugin interfaces may include providing a plugin template to a user device 108. The plugin template may comprise source code and build tooling, with the source code comprising predefined integration points for interacting with the provider-specific resources using the normalized data model. The management platform 106 may then receive a plugin interface from the user device 108, where the plugin interface comprises a binary executable compiled from the source code using the build tooling.

In some implementations, the management platform 106 may perform additional steps related to financial operations. These may include retrieving financial data from the provider-specific resources using the generated plugin interfaces, transforming the financial data into a normalized cost format according to the defined schemas, and generating consolidated financial reporting based on the normalized cost format.

The management platform 106 may store the normalized data model in a transactional database, such as the data store 208. The transactional database may comprise tables having the defined schemas. Additionally, the management platform 106 may index the normalized data model in a non-transactional database.

When orchestrating the subset of the provider-specific resources in step 1108, the management platform 106 may map dependencies between the subset of the provider-specific resources to generate a process workflow based on the relationships maintained in the normalized data model. The management platform 106 may then configure the subset of the provider-specific resources according to this process workflow.

In cases where the service request specifies an application, the orchestration in step 1108 may involve analyzing the normalized data model to identify the subset of the provider-specific resources for an infrastructure and a day-2 environment of the application. This analysis is based on the relationships maintained in the normalized data model. The management platform 106 may then deploy the application by configuring the identified subset of provider-specific resources, and subsequently tear down the application by reconfiguring these resources when necessary.

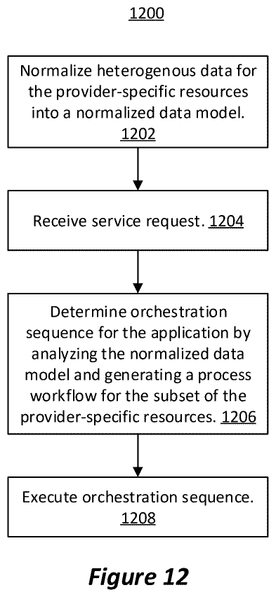

FIG. 12 is a flowchart of an application deployment method 1200, according to some implementations. The application deployment method 1200 will be described with the application deployment method 1200 of FIGS. 1-3. The application deployment method 1200 may be implemented in the management environment 100. Specifically, the management platform 106 may perform the application deployment method 1200.

The management platform 106 may perform a step 1202 of normalizing heterogeneous data for provider-specific resources (e.g., computing resources 104) into a normalized data model. This step involves transforming definitions for the provider-specific resources into defined schemas. The normalized data model maintains relationships between components to represent dependencies across the provider-specific resources.

The management platform 106 may perform a step 1204 of receiving a service request specifying an application. The service request may be received through the user interface 310.

The management platform 106 may perform a step 1206 of determining, based on the service request and the normalized data model, an orchestration sequence for the application. This step involves analyzing the normalized data model to identify a subset of the provider-specific resources for an infrastructure and a day-2 environment of the application based on the relationships maintained in the normalized data model. The analysis generates a process workflow for the subset of the provider-specific resources.

In some implementations, determining the orchestration sequence may further comprise analyzing dependencies for the application to identify the subset of the provider-specific resources for the infrastructure of the application. This may involve examining the relationships maintained in the normalized data model to understand how different components of the application interact and depend on each other.

Additionally, determining the orchestration sequence may include analyzing policies for the application to identify the subset of the provider-specific resources for the day-2 environment of the application. These policies may define operational requirements, security measures, or performance standards that need to be implemented as part of the application deployment.

The management platform 106 may perform a step 1208 of executing the orchestration sequence by configuring the subset of the provider-specific resources according to the process workflow. This step involves deploying and configuring the necessary resources to support both the infrastructure and day-2 environment of the application.

In some aspects, the service request may be associated with a context of a user and the application. The context may comprise a group of the user, and the context may further comprise a deployment environment of the application. When executing the orchestration sequence, the subset of the provider-specific resources may be configured according to this context.

The subset of the provider-specific resources may be identified based on a deployment environment, performance requirements, or cost constraints of the application. For example, different resources might be selected for a development environment compared to a production environment, or based on specific performance needs or budget limitations.

In some implementations, the management platform 106 may also perform steps of storing the normalized data model in a transactional database (e.g., data store 208), the transactional database comprising tables having the defined schemas, and indexing the normalized data model in a non-transactional database.

The management platform 106 may also perform steps of generating plugin interfaces for the provider-specific resources and obtaining the heterogeneous data for the provider-specific resources using the generated plugin interfaces. The subset of the provider-specific resources may be configured using these generated plugin interfaces during the execution of the orchestration sequence.

Although this disclosure describes or illustrates particular operations as occurring in a particular order, this disclosure contemplates the operations occurring in any suitable order. Moreover, this disclosure contemplates any suitable operations being repeated one or more times in any suitable order. Although this disclosure describes or illustrates particular operations as occurring in sequence, this disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. The acts can operate in an operating system environment or as stand-alone routines occupying all or a substantial part of the system processing.

While this disclosure has been described with reference to illustrative implementations, this description is not intended to be construed in a limiting sense. Various modifications and combinations of the illustrative implementations, as well as other implementations of the disclosure, will be apparent to persons skilled in the art upon reference to the description. It is therefore intended that the appended claims encompass any such modifications or implementations.

What is claimed is:

1. A computer-implemented method, comprising:
normalizing heterogeneous data for provider-specific resources into a normalized data model by transforming definitions for the provider-specific resources into defined schemas, wherein the normalized data model maintains relationships between components to represent dependencies across the provider-specific resources;
receiving a service request specifying an application;
determining, based on the service request and the normalized data model, an orchestration sequence for the application by:
analyzing the normalized data model to identify a subset of the provider-specific resources for an infrastructure and a day-2 environment of the application based on the relationships maintained in the normalized data model; and
generating a process workflow for the subset of the provider-specific resources; and
executing the orchestration sequence by configuring the subset of the provider-specific resources according to the process workflow.

2. The computer-implemented method of claim 1, wherein the service request is associated with a context of a user and the application, and the subset of the provider-specific resources are configured according to the context.

3. The computer-implemented method of claim 2, wherein the context comprises a group of the user, and the context further comprises a deployment environment of the application.

4. The computer-implemented method of claim 1, wherein the application is a multi-tier application, and determining the orchestration sequence further comprises:
analyzing dependencies for the multi-tier application to identify the subset of the provider-specific resources for the infrastructure of the application; and
analyzing policies for the multi-tier application to identify the subset of the provider-specific resources for the day-2 environment of the application.

5. The computer-implemented method of claim 1, wherein the subset of the provider-specific resources is identified based on a deployment environment, performance requirements, or cost constraints of the application.

6. The computer-implemented method of claim 1, further comprising:
storing the normalized data model in a transactional database, the transactional database comprising tables having the defined schemas; and
indexing the normalized data model in a non-transactional database.

7. The computer-implemented method of claim 1, wherein determining the orchestration sequence further comprises:
mapping dependencies between the subset of the provider-specific resources to generate the process workflow based on the relationships maintained in the normalized data model.

8. The computer-implemented method of claim 1, further comprising:
generating plugin interfaces for the provider-specific resources; and
obtaining the heterogeneous data for the provider-specific resources using the generated plugin interfaces,
wherein the subset of the provider-specific resources is configured using the generated plugin interfaces.

9. A computer device, comprising:
a processor; and
a non-transitory computer-readable medium storing instructions which, when executed by the processor, cause the processor to:
normalize heterogeneous data for provider-specific resources into a normalized data model by transforming definitions for the provider-specific resources into defined schemas, wherein the normalized data model maintains relationships between components to represent dependencies across the provider-specific resources;
receive a service request specifying an application;
determine, based on the service request and the normalized data model, an orchestration sequence for the application by:
analyzing the normalized data model to identify a subset of the provider-specific resources for an infrastructure and a day-2 environment of the application based on the relationships maintained in the normalized data model; and
generating a process workflow for the subset of the provider-specific resources; and
execute the orchestration sequence by configuring the subset of the provider-specific resources according to the process workflow.

10. The computer device of claim 9, wherein the service request is associated with a context of a user and the application, and the subset of the provider-specific resources are configured according to the context.

11. The computer device of claim 10, wherein the context comprises a group of the user, and the context further comprises a deployment environment of the application.

12. The computer device of claim 9, wherein the application is a multi-tier application, and the instructions to determine the orchestration sequence cause the processor to:
analyze dependencies for the multi-tier application to identify the subset of the provider-specific resources for the infrastructure of the application; and
analyze policies for the multi-tier application to identify the subset of the provider-specific resources for the day-2 environment of the application.

13. The computer device of claim 9, wherein the subset of the provider-specific resources is identified based on a deployment environment, performance requirements, or cost constraints of the application.

14. The computer device of claim 9, wherein the instructions further cause the processor to:
store the normalized data model in a transactional database, the transactional database comprising tables having the defined schemas; and
index the normalized data model in a non-transactional database.

15. The computer device of claim 9, wherein the instructions to determine the orchestration sequence cause the processor to:
map dependencies between the subset of the provider-specific resources to generate the process workflow based on the relationships maintained in the normalized data model.

16. The computer device of claim 9, wherein the instructions further cause the processor to:
generate plugin interfaces for the provider-specific resources; and
obtain the heterogeneous data for the provider-specific resources using the generated plugin interfaces,
wherein the subset of the provider-specific resources is configured using the generated plugin interfaces.

17. A computer system, comprising:
a plurality of provider-specific resources in public clouds; and
a management server configured to:
normalize heterogeneous data for provider-specific resources into a normalized data model by transforming definitions for the provider-specific resources into defined schemas, wherein the normalized data model maintains relationships between components to represent dependencies across the provider-specific resources;
receive a service request specifying an application;
determine, based on the service request and the normalized data model, an orchestration sequence for the application by:
analyzing the normalized data model to identify a subset of the provider-specific resources for an infrastructure and a day-2 environment of the application based on the relationships maintained in the normalized data model; and
generating a process workflow for the subset of the provider-specific resources; and
execute the orchestration sequence by configuring the subset of the provider-specific resources according to the process workflow.

18. The computer system of claim 17, wherein the service request is associated with a context of a user and the application, the subset of the provider-specific resources is configured according to the context, the context comprises a group of the user, and the context further comprises a deployment environment of the application.

19. The computer system of claim 17, wherein the application is a multi-tier application, and the management server is further configured to determine the orchestration sequence by:
analyzing dependencies for the multi-tier application to identify the subset of the provider-specific resources for the infrastructure of the application; and
analyzing policies for the multi-tier application to identify the subset of the provider-specific resources for the day-2 environment of the application.

20. The computer system of claim 17, wherein the subset of the provider-specific resources is identified based on a deployment environment, performance requirements, or cost constraints of the application.
